(19) United States
(12) Patent Application Publication
(10) Pub. No.: US 2025/0109767 A1
(43) Pub. Date: Apr. 3, 2025

(54) SELF-ALIGNING, SCREW-LESS HINGE

(71) Applicant: Todd Noe, Del Mar, CA (US)

(72) Inventor: Todd Noe, Del Mar, CA (US)

(21) Appl. No.: 18/375,426

(22) Filed: Sep. 29, 2023

(51) Int. Cl. F16C 11/04

(52) U.S. Cl. CPC F16C 11/04

(57) ABSTRACT

The invention is a self-aligning, screw-less hinge containing only two components, a top portion and bottom portion. Instead of leafs, knuckles and pin as in a conventional hinge, a door and door frame using this hinge can be interfaced in one operation; and door removal is also one operation.

### TECHNICAL FIELD

The invention is a hinge system for connecting a door to a door frame.

### BACKGROUND OF INVENTION

Hinges have been around of hundreds of years. Hinges typically comprise two components, one mounted to the door frame and the other mounted to the door such that when attached to one another, the door can swing from fully closed (e.g. covering the door-frame opening) to fully open (e.g. exposing the door frame opening.

Conventional hinges comprise two leafs, with at least two screw holes, and at least two knuckles, such that when the knuckles are interleaved and aligned, a pin is inserted through the knuckles thus joining the two leafs while allowing the door to rotate on the pin, acting as an axis.

Any faulty adjustment in the positions of the two leafs can cause misalignment when they are interleaved and pinned.

In order to remove a door from a door frame, each pin must be removed from each hinge. In order to mount a door on a door frame, the hinge knuckles must be interleaved and aligned so that the knuckle shafts line up in order to insert the pin through all of them.

### BRIEF DESCRIPTION OF THE INVENTION

The invention is a hinge comprising a top and bottom portion. The top portion has a cylindrical shaft and a rectangular tab oriented at right angles to one another. The bottom portion has a cylindrical spindle and a rectangular tab oriented at right angles to the spindle

The top portion's rectangular tab is inserted into a slot on a door that is dimensioned to provide a snug fit with the tab. The bottom portion's rectangular tab is inserted into a slot on a door frame that is dimensioned to provide a snug fit the tab.

Once the tabs are fully inserted, they are welded. When the bottom portions are all welded to the door frame, and the top portions are all welded to the door, the door may be mounted simply by orienting it vertically, and raising it so that the bottoms of the cylindrical shafts are right above the tops of the cylindrical spindles. Once lowered into place, the door is self-aligned with the door frame and door frame opening.

Subsequent door removal is simply a matter of lifting the door up so as to raise the bottom of the cylindrical shafts above the tops of the cylindrical spindles. There are no pins to remove, and the process of mounting or dismounting can be done in a single step.

### BRIEF DESCRIPTION OF DRAWINGS

FIG. 1 shows a bottom portion comprising a rectangular tab and cylindrical spindle.

FIG. 2 shows a top portion comprising a rectangular tab and cylindrical shaft

FIG. 3 shows an exploded view of the top portion, washer and bottom portion.

FIG. 4 shows the top portion, bottom portion and washer as assembled.

FIG. 5 shows a door frame and door showing the locations of mating slots in each.

FIG. 6a shows a top-down view of door frame and door with mating slots.

FIG. 6b shows a top-down view of the hinge with rectangular tabs.

FIG. 6c shows a top-down view of door frame and door with hinge attached.

FIG. 7 shows a perspective view with door, door frame and hinges attached.

FIG. 8 shows a conventional hinge with leafs, knuckles and pin.

### DETAILED DESCRIPTION OF INVENTION

Doors and door frames have been around for hundreds of years. Door hinges were invented to attach doors to door frames so that a door could open and close while staying aligned with the door-frame opening.

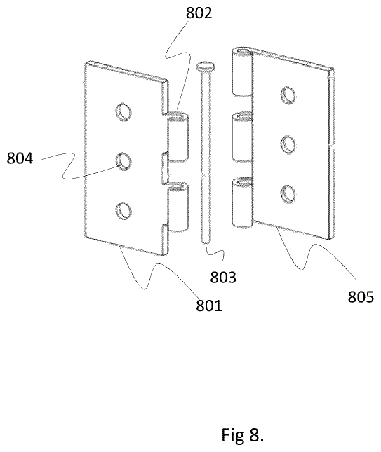

Most conventional hinges are depicted in FIG. 8. One leaf (801) with at least two screw holes (804) has at least two knuckles (802). It's mating leaf (805) has at least two knuckles so that when moved such that the knuckle shafts are interleaved and aligned, a pin (803) can be inserted from the top down through the aligned knuckles connecting the two leafs and allowing them to rotate on the pin axis.

With a conventional hinge, one leaf is mounted to a door frame and its mating leaf is mounted to a door's edge. Their vertical positions, relative to one another must be precisely chosen to insure that when the knuckles are aligned, the door is essentially still vertically oriented, and that the door is positioned such that when closed it covers or fits into the door-frame opening. It is not uncommon for hinge leafs to be adjusted, after installation, to compensate for slightly skewed installation positions.

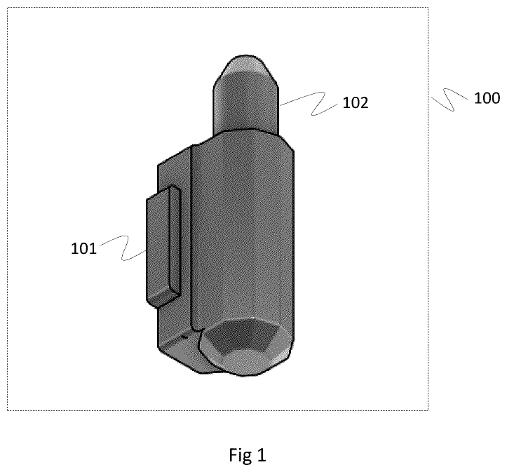

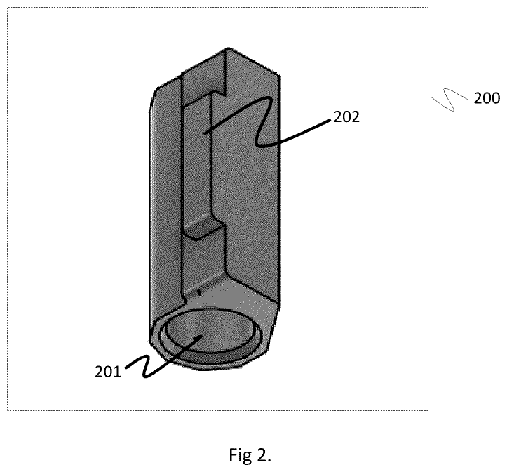

The invention hinge comprises only two rather than three components. A bottom portion, as shown in FIG. 1 (100) is a molded structure comprising a rectangular tab (101) and a cylindrical spindle (102). A top portion, as shown in FIG. 2, is a molded structure comprising a rectangular tab (202) and cylindrical shaft (201).

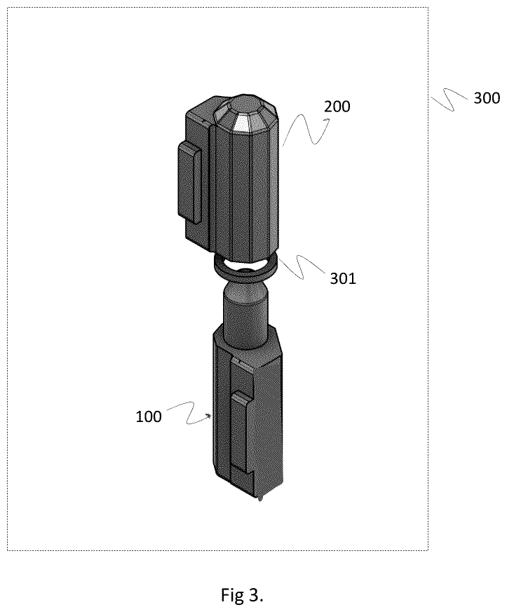

The top and bottom portion, as shown in an exploded view in FIG. 3, allows assembling them by placing the bottom portion's (100) cylindrical spindle into the top portion's (200) cylindrical shaft. A washer (301), with smooth faces, is placed on the bottom portion's cylindrical spindle allowing for smooth rotation and reducing top portion and bottom portion wear.

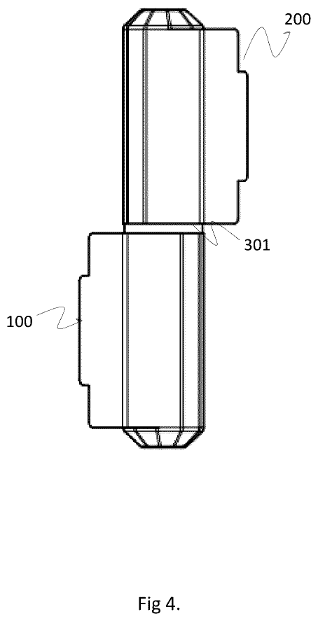

FIG. 4 depicts the assembled hinge with bottom portion's (100) cylindrical spindle fully inserted into the top portion's (200) cylindrical shaft with the two portions separated only by the thickness of the smooth, wear-reducing washer (301).

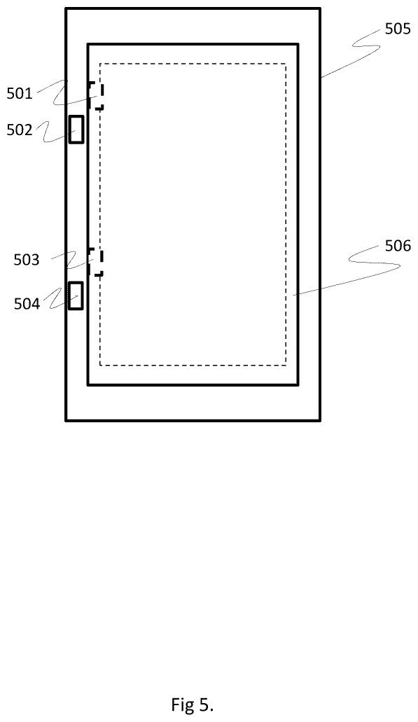

Prior to hinge installation in door frame and door, as shown in FIG. 5, rectangular slots (502 and 504) are cut in the door frame (505). Optimal placement and orientation can be achieved using computer numerical control (CNC) laser cutting. Similarly, rectangular slots (501 and 503) are cut in the door (506). The slots are located so that when the hinges are attached and later interfaced, the hinges are properly aligned with door and door frame. Pairs of slots that accommodate a hinge are hereinafter referred to as “complementary slots.” Thus, slots 501 and 502 are complementary slots, and slots 503 and 504 are complementary slots. The slots cut into the door frame will always be lower than those cut into the door. In that way, the hinge top portion is always above its complementary bottom portion. When all hinge portions are properly inserted in their respective complementary slots, the portion's rectangular tabs are welded in place.

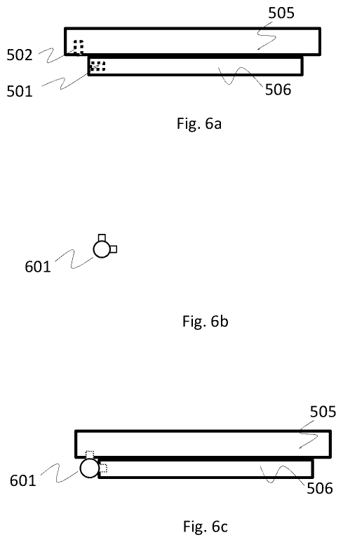

FIG. 6a is a top-down view of door (506) and door frame (505) showing the lateral juxtapositions of the complementary slots 501 and 502. FIG. 6b shows the assembled hinge from a top-down view including rectangular tabs. And, FIG. 6c shows a top-down view of the door (506) and door frame (505) with the assembled hinge (601) installed in the complementary slots.

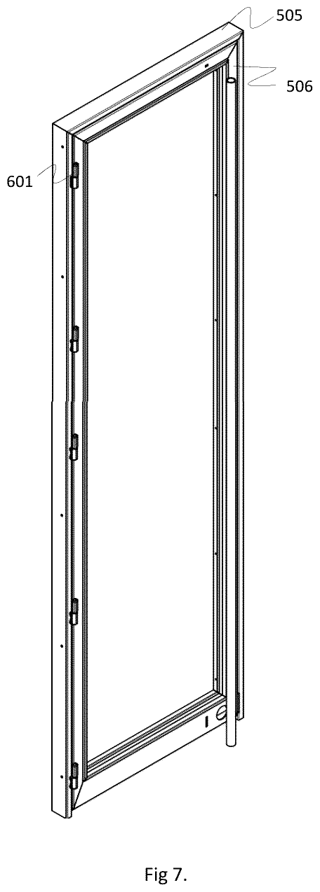

FIG. 7 is a perspective view showing the door frame (505) and door (506) in closed position with hinges 601, 701, 702, and 703 installed in their respective complementary slots.

It should be noted that the molded top and bottom portions of the hinge may be made of metallic or non-metallic materials. The materials and dimensions chosen are dependent on the rigidity of the door and door frame, and on the weight of the door.

It should also be noted that the drawings and specifications describe welding the rectangular portions to their respective complementary slots. That is specific to a case where door frame and door are metallic and can be welded.

In other cases, the rectangular tabs, after being fully inserted in their respective complementary slots, may be held in place by sufficiently strong bonding agents operative to form a rigid, secure attachment.

The figures and descriptions are exemplary and should not be read as limiting the invention scope.

This hinge invention would provide the same utility for mounting metallic doors to metallic door frames, cabinet doors to cabinet wood frames, and other wooden doors to wooden door frames. That is, installation requires a single operation of, after proper installation of all hinge portions, lifting the door such that the bottom of its hinge portions' cylindrical shafts are just above the tops of the door frame's hinge portions' cylindrical spindles. Then, the door is lowered into place. To remove the door, it is only a matter of lifting the door so that its hinge portions' cylindrical shafts are free of the door frame portions' cylindrical spindles. There are no pins to insert or pull out for installation or removal.

What is claimed is:

1. A self-aligning, screw-free hinge comprising;
a bottom portion comprising a rectangular bottom interface tab and a cylindrical spindle wherein the rectangular bottom interface tab protrudes at right angles to the cylindrical spindle;
a top portion comprising a rectangular top interface tab and cylindrical shaft wherein the rectangular top interface tab protrudes at right angles to the cylindrical shaft;
a flexible washer, smooth on both faces, operative to slide down the cylindrical spindle and sit snugly at a non-free-end of the cylindrical spindle;
the rectangular bottom interface tab is operative to fit snugly into a mating door-frame interface slot; and
the rectangular top interface tab is operative to fit snugly into a mating door interface slot.

2. A claim as in claim 1 wherein:
the bottom portion and the top portion are each a molded, single-piece structure.

3. A claim as in claim 2 wherein:
the bottom portion and the top portion comprise metal material.

4. A claim as in claim 2 wherein:
the bottom portion and the top portion comprise non-metallic material.

5. A claim as in claim 1 wherein:
the flexible washer comprises metallic material.

6. A claim as in claim 1 wherein:
the flexible washer comprises non-metallic material.

7. A method of use claim comprising:
a. inserting a bottom portion into a complementary door-frame mating slot;
b. inserting a top portion into a complementary door mating slot;
repeating steps a and b until all slots hold their respective bottom or top portions;
sliding a washer down each of the bottom portion cylindrical spindles;
lifting a door so it is vertically oriented and its top portions are higher than the upper end of their complementary door-frame bottom portions' cylindrical spindles;
adjusting the door position so that each top portion's hollow shaft is just above each bottom portion's spindle; and
lowering the door, vertically, until each bottom portion spindle is fully inserted into each top portion hollow shaft.
